(19) United States
(12) Patent Application Publication
(10) Pub. No.: US 2014/0255116 A1
(43) Pub. Date: Sep. 11, 2014

(54) ROTARY CUTTING TOOL, REPLACEABLE CUTTING INSERT AND METHOD OF MAKING REPLACEABLE CUTTING INSERT

(71) Applicant: KENNAMETAL INC., Latrobe, PA (US)

(72) Inventors: Neal S. Myers, Greensburg, PA (US); Juergen Schwaegerl, Vohenstrauss (DE)

(73) Assignee: KENNAMETAL INC., Latrobe, PA (US)

(21) Appl. No.: 13/792,032

(22) Filed: Mar. 9, 2013

(51) Int. Cl. B23B 51/06

(52) U.S. Cl. CPC B23B 51/06; B23B 2200/36; B23B 2250/12; B23B 2251/50
USPC 408/59; 264/328.1

(57) ABSTRACT

A replaceable cutting insert includes a cutting insert body having a forward cutting face and an opposing rearward base, an inlet coolant channel formed in the cutting insert body, a first outlet coolant channel formed in the cutting insert body and in fluid communication with the inlet coolant channel and a second outlet coolant channel formed in the cutting insert body and in fluid communication with the inlet coolant channel. The inlet coolant channel includes a longitudinal axis that is not axially aligned with either a first longitudinal axis of the first outlet coolant channel or a second longitudinal axis of the second outlet coolant channel. A rotary cutting tool incorporating the replaceable cutting insert is also provided. A method of making a replaceable cutting insert is also provided.

### BACKGROUND OF THE INVENTION

The invention pertains generally to a rotary cutting tool (e.g. a drill, a milling cutter, a reamer or similar device) having, for example, a tool shank or tool body and a replaceable or an exchangeable cutting insert made of or including at least one hard cutting material, e.g. a tungsten carbide cutting alloy, oxide ceramic or similar material. More particularly, the invention pertains to a replaceable cutting insert with internal channels formed therein for delivering a coolant material and a related method for making the replaceable cutting insert having internal channels formed therein.

During operation of a rotary cutting tool (e.g. a drilling operation), substantial stresses are exerted on the various tool components. Therefore, the tool should be sufficiently strong and durable. It is known to produce a replaceable cutting insert that can be inserted into the body of the tool. The cutting insert, when sufficiently worn by use in a cutting operation, can be removed and replaced with a new cutting insert. In the particular case of a drill, the cutting insert often contains the entire cutting end of the drill, including the drill tip, the cutting faces, the cutting edges, as well as portions of the chip flutes. Such a cutting insert is connected to the drill body in a secure but removable fashion.

Also during operation of a rotary cutting tool (e.g. a drilling operation), heat is generated at the interface between the cutting insert and the location where material is being removed from a workpiece (i.e., the insert-workpiece interface). It is well-known that excessive heat at the insert-workpiece interface can negatively impact upon the useful tool life of the cutting insert. As can be appreciated, a shorter useful tool life increases operating costs and decreases overall production efficiency. Hence, there are readily apparent advantages connected with decreasing the heat at the insert-workpiece interface. It is known to provide a coolant material to the insert-workpiece interface to decrease the heat and increase the useful tool life.

However, it will be appreciated that most known systems for providing a coolant material to the insert-workpiece interface are difficult and/or expensive to manufacture while still maintaining the overall integrity of the cutting tool components. Thus, it would be desirable to provide an improved rotary cutting tool and, in particular, an improved cutting insert that overcomes limitations, shortcomings and/or disadvantages of known rotary cutting tools and cutting inserts.

### SUMMARY OF THE INVENTION

In accordance with an aspect of the invention, a replaceable cutting insert includes a cutting insert body having a forward cutting face and an opposing rearward base and an inlet coolant channel formed in the cutting insert body and defining an inlet opening at the rearward base of the cutting insert body, the inlet coolant channel having a longitudinal axis. The replaceable cutting insert also includes a first outlet coolant channel formed in the cutting insert body and in fluid communication with the inlet coolant channel, the first outlet coolant channel defining a first outlet opening at the forward cutting face of the cutting insert body, wherein the first outlet coolant channel includes a first longitudinal axis that is not axially aligned with the longitudinal axis of the inlet coolant channel. The replaceable cutting insert further includes a second outlet coolant channel formed in the cutting insert body and in fluid communication with the inlet coolant channel, the second outlet coolant channel defining a second outlet opening at the forward cutting face of the cutting insert body, wherein the second outlet coolant channel includes a second longitudinal axis that is not axially aligned with the longitudinal axis of the inlet coolant channel.

In accordance with another aspect of the invention, a replaceable cutting insert includes: a cutting insert body having a forward cutting face and an opposing rearward base; a first inlet coolant channel formed in the cutting insert body and defining a first inlet opening at the rearward base of the cutting insert body, the first inlet coolant channel having a first longitudinal axis; a second inlet coolant channel formed in the cutting insert body and defining a second inlet opening at the rearward base of the cutting insert body, the second inlet coolant channel having a second longitudinal axis; a first outlet coolant channel formed in the cutting insert body and in fluid communication with the first inlet coolant channel, the first outlet coolant channel defining a first outlet opening at the forward cutting face of the cutting insert body, wherein the first outlet coolant channel includes a third longitudinal axis that is not axially aligned with the first longitudinal axis of the first inlet coolant channel; and a second outlet coolant channel formed in the cutting insert body and in fluid communication with the second inlet coolant channel, the second outlet coolant channel defining a second outlet opening at the forward cutting face of the cutting insert body, wherein the second outlet coolant channel includes a fourth longitudinal axis that is not axially aligned with the second longitudinal axis of the second inlet coolant channel.

In accordance with another aspect of the invention, a rotary cutting tool includes a tool body having an axial forward end and an axial rearward end, the tool body defining a coolant channel that extends therethrough from the axial rearward end to the axial forward end and a replaceable cutting insert structured and arranged for releasable attachment to the axial forward end of the tool body. The replaceable cutting insert includes a cutting insert body having a forward cutting face and an opposing rearward base positionable adjacent the axial forward end of the tool body, and an inlet coolant channel formed in the cutting insert body and defining an inlet opening at the rearward base of the cutting insert body, the inlet coolant channel having a longitudinal axis, wherein the inlet coolant channel is positionable to be in fluid communication with the coolant channel of the tool body. The replaceable cutting insert also includes a first outlet coolant channel formed in the cutting insert body and in fluid communication with the inlet coolant channel, the first outlet coolant channel defining a first outlet opening at the forward cutting face of the cutting insert body, wherein the first outlet coolant channel includes a first longitudinal axis that is not axially aligned with the longitudinal axis of the inlet coolant channel. The replaceable cutting insert further includes a second outlet coolant channel formed in the cutting insert body and in fluid communication with the inlet coolant channel, the second outlet coolant channel defining a second outlet opening at the forward cutting face of the cutting insert body, wherein the second outlet coolant channel includes a second longitudinal axis that is not axially aligned with the longitudinal axis of the inlet coolant channel

In accordance with yet another aspect of the invention, a method of making a replaceable cutting insert includes forming a hard cutting material mixture, injecting the hard cutting material mixture into a die for forming a replaceable cutting insert body having an inlet coolant channel in fluid communication with a first outlet coolant channel and a second outlet coolant channel, wherein the first outlet coolant channel includes a first longitudinal axis that is not axially aligned with a longitudinal axis of the inlet coolant channel and the second outlet coolant channel includes a second longitudinal axis that is not axially aligned with the longitudinal axis of the inlet coolant channel. The method also includes removing the replaceable cutting insert body from the die. In one aspect, the method further includes configuring the die to include a first linear tooling element for forming the first outlet coolant channel, a second linear tooling element for forming the second outlet coolant channel and a third linear tooling element for forming the inlet coolant channel, wherein the first linear tooling element is interconnected with the third linear tooling element and the second linear tooling element is interconnected with the third linear tooling element. In another aspect, the method includes withdrawing the first and second linear tooling elements before removing the replaceable cutting insert body from the die. In yet another aspect, alternatively the method includes withdrawing the first and second linear tooling elements after removing the replaceable cutting insert body from the die.

These and other aspects of the present invention will be more fully understood following a review of this specification and drawings.

### BRIEF DESCRIPTION OF THE DRAWINGS

FIG. 1 illustrates a rotary cutting tool, in accordance with an aspect of the invention.

FIG. 2 is a sectional view of the rotary cutting tool illustrated in FIG. 1, in accordance with an aspect of the invention.

FIG. 3 is a sectional view of the rotary cutting tool body illustrated in FIG. 2, in accordance with an aspect of the invention.

FIG. 4 is a sectional view of the replaceable cutting insert illustrated in FIG. 2, in accordance with an aspect of the invention.

FIG. 5 is a top view of the rotary cutting tool and, in particular, the replaceable cutting insert illustrated in FIG. 1, in accordance with another aspect of the invention.

FIG. 6 is a sectional view of an additional replaceable cutting insert, in accordance with an aspect of the invention.

FIG. 7A is a schematic representation of making a replaceable cutting insert, in accordance with an aspect of the invention.

FIG. 7B is a schematic representation of making a replaceable cutting insert, in accordance with another aspect of the invention.

### DETAILED DESCRIPTION

The following description is for purposes of illustrating various aspects of the invention only and not for purposes of limiting the scope of the invention.

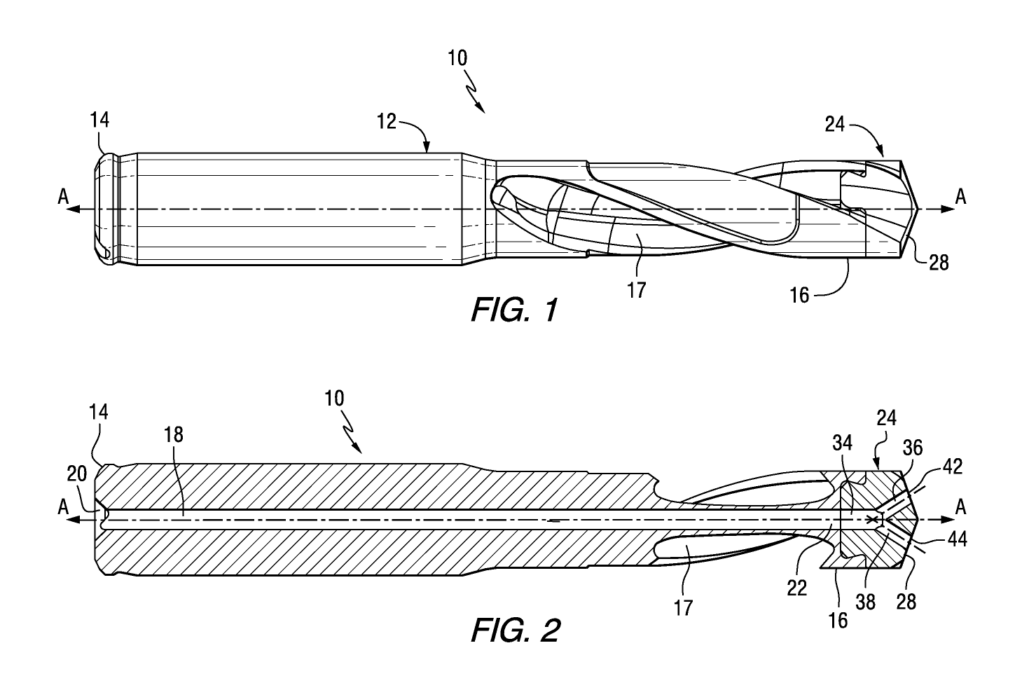

Referring generally to FIGS. 1-5, there is illustrated a rotary cutting tool, generally designated as reference number 10, and components thereof in accordance with various aspects of the invention. For illustration purposes only, rotary cutting tool 10 is shown in the form of a drilling tool but it will be appreciated that the invention has application to various kinds of rotary cutting tools (e.g., a milling cutter, a reamer or similar device) useful in various kinds of cutting operations.

Rotary cutting tool 10 includes a tool body 12, in accordance with an aspect of the invention. The tool body 12 includes an axial rearward end 14 and an axial forward end 16. In the example of the rotary cutting tool 10 being in the form of a drill, the tool body 12 may define one or more flutes 17 formed therein. The tool body 12 also includes a central longitudinal axis A-A which extends therethrough from the axial rearward end 14 to the axial forward end 16. In one aspect, the central longitudinal axis A-A is also a central rotational axis of the rotary cutting tool 10.

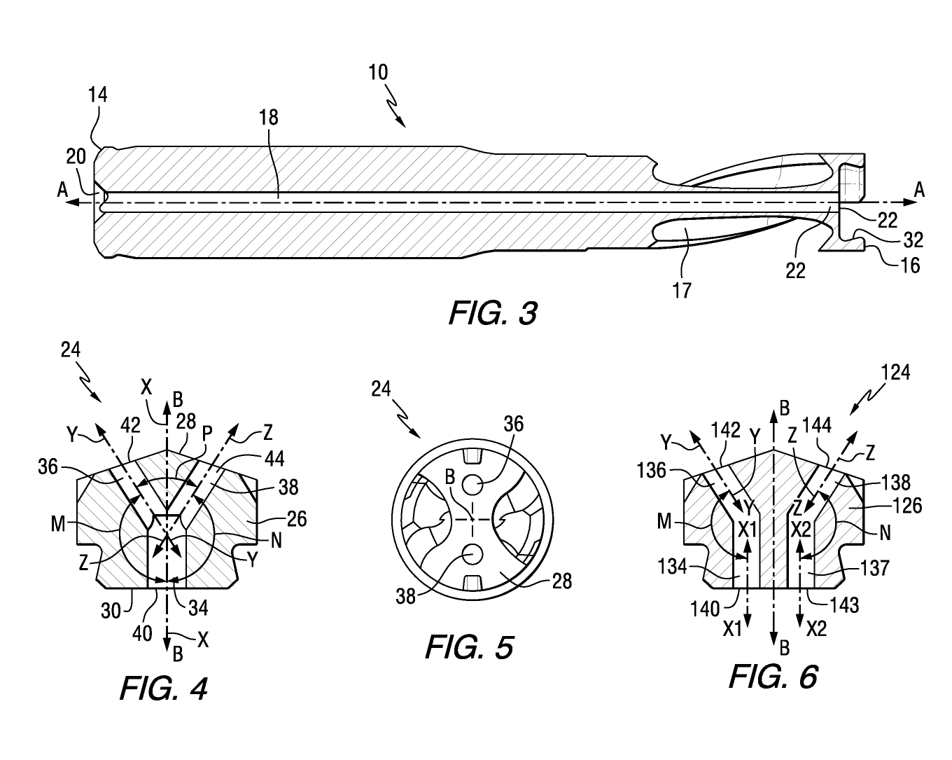

As shown in FIGS. 2 and 3, the tool body 12 defines a coolant channel 18 that extends therethrough from the axial rearward end 14 to the axial forward end 16. In one aspect, the coolant channel 18 is located at or adjacent the central longitudinal axis A-A of the rotary cutting tool 10, although it will be appreciated that the coolant channel 18 may be located at other locations in or throughout the tool body 12. The coolant channel 18 is configured to provide for a coolant material to enter a coolant channel inlet 20 at or adjacent the axial rearward end 14 and flow through the coolant channel 18 to a coolant channel outlet 22 at or adjacent the axial forward end 16. The coolant channel 18 is illustrated as linear, but it will be appreciated that the coolant channel 18 may be formed in other shapes or configurations, e.g. helical.

As shown in FIGS. 1-2 and 4-5, the rotary cutting tool 10 further includes a replaceable cutting insert, generally designated as reference number 24, in accordance with an aspect of the invention. The replaceable cutting insert 24 includes a cutting insert body 26 having a forward cutting face 28 and a generally opposing rearward base 30. The replaceable cutting insert 24 is structured and arranged for releasable attachment to the axial forward end 16 of the tool body 12. In one aspect, the replaceable cutting insert 24 is releasably attached to the axial forward end 16 of the tool body 12 by the rearward base 30 being structured and arranged for cooperating with a pocket 32 formed in the axial forward end 16 of the tool body 12. In one aspect, the replaceable cutting insert 24 is releasably attached to the axial forward end 16 of the tool body 12 by mechanical connection. Advantageously, this configuration allows for the cutting insert 24 to be easily and quickly attached and removed from the tool body 12 once the cutting insert has been used and needs replaced due to wear.

The replaceable cutting insert 24 includes a central longitudinal axis B-B which extends therethrough from the forward cutting face 28 to the opposing rearward base 30. In one aspect, the central longitudinal axis B-B is also a central rotational axis of the replaceable cutting insert 24.

Referring to FIGS. 2 and 4-5, the replaceable cutting insert 24 further includes an inlet coolant channel 34, a first outlet coolant channel 36 and a second outlet coolant channel 38 all formed in the cutting insert body 26, in accordance with an aspect of the invention. The first outlet coolant channel 36 and the second outlet coolant channel 38 are structured and arranged to be in fluid communication with the inlet coolant channel 34. The inlet coolant channel 34 defines an inlet opening 40 at or adjacent the rearward base 40 of the cutting insert body 26. The first outlet coolant channel 36 defines an outlet opening 42 at or adjacent the forward cutting face 28 of the cutting insert body 26. The second outlet coolant channel 38 defines an outlet opening 44 at or adjacent the forward cutting face 28 of the cutting insert body 26.

In one aspect, the inlet coolant channel 34 is located at or adjacent the central longitudinal axis B-B of the replaceable cutting insert 24, although it will be appreciated that the coolant channel 34 may be located at other locations in or throughout the cutting insert body 26. The inlet coolant channel 34 is structured and arranged to be in fluid communication with the coolant channel 18 of the tool body 12. In one aspect, the inlet opening 40 is positionable adjacent the coolant channel outlet 22 of coolant channel 18 so as to be in fluid communication therewith.

Thus, it will be appreciated that the described and illustrated configuration of coolant channel 18, inlet coolant channel 34 and first and second outlet coolant channels 36, 38 provides for a coolant material to pass through the rotary cutting tool 10 and be delivered to the forward cutting face 28 of the replaceable cutting insert 24, i.e. to the insert-workpiece interface to decrease the heat and increase the useful life of the rotary cutting tool 10 and, more particularly, to increase the useful life of the replaceable cutting insert 24.

As illustrated in FIG. 4, the inlet coolant channel 34 includes a longitudinal axis, for example, axis X-X. In one example, the longitudinal axis X-X may be coincident with the central longitudinal axis B-B. In one example, the longitudinal axis X-X may extend in the same direction as the central longitudinal axis B-B of the replaceable cutting insert 24. In addition, the first outlet coolant channel 36 includes a longitudinal axis, for example, axis Y-Y and the second outlet coolant channel 38 includes a longitudinal axis, for example, axis Z-Z.

In accordance with an aspect of the invention, while the inlet coolant channel 34 is in fluid communication with the first outlet coolant channel 36, the longitudinal axis X-X of the inlet coolant channel 34 is not axially aligned with the longitudinal axis Y-Y of the first outlet coolant channel 36. In another aspect, the inlet coolant channel 34 is linear and the first outlet coolant channel 36 is linear and the inlet coolant channel 34 and the first outlet coolant channel 36 are not axially aligned.

In accordance with an aspect of the invention, while the inlet coolant channel 34 is in fluid communication with the second outlet coolant channel 38, the longitudinal axis X-X of the inlet coolant channel 34 is not axially aligned with the longitudinal axis Z-Z of the second outlet coolant channel 38. In another aspect, the inlet coolant channel 34 is linear and the second outlet coolant channel 38 is linear and the inlet coolant channel 34 and the second outlet coolant channel 38 are not axially aligned.

Still referring to FIG. 4, another aspect of the invention is that the first outlet coolant channel 36 extends at an angle M relative to the inlet coolant channel 34. In other words, the longitudinal axis Y-Y of the first outlet coolant channel 36 extends at the angle M relative to the longitudinal axis X-X of the inlet coolant channel 34. The angle M may be, for example, in the range of about 90 degrees to about 160 degrees.

Yet another aspect of the invention is that the second outlet coolant channel 38 extends at an angle N relative to the inlet coolant channel 34. In other words, the longitudinal axis Z-Z of the second outlet coolant channel 38 extends at the angle N relative to the longitudinal axis X-X of the inlet coolant channel 34. The angle N may be, for example, in the range of about 90 degrees to about 160 degrees.

In another aspect of the invention, the longitudinal axis Y-Y of the first outlet coolant channel 36 is not axially aligned with the longitudinal axis Z-Z of the second outlet coolant channel 38. In another aspect of the invention, the longitudinal axis Y-Y of the first outlet coolant channel 36 is positioned at an angle P relative to the longitudinal axis Z-Z of the second outlet coolant channel 38. The angle P may be, for example, in the range of about 20 degrees to about 180 degrees.

Referring to FIG. 6, there is illustrated an additional replaceable cutting insert 124, in accordance with additional aspects of the invention. The replaceable cutting insert 124 is similar in most aspects to the replaceable cutting insert 24 described herein, but the replaceable cutting insert 124 further includes a first inlet coolant channel 134 (defining opening 140) in fluid communication with a first outlet coolant channel 136 (defining opening 142) and a second inlet coolant channel 137 (defining opening 143) in fluid communication with a second outlet coolant channel 138(defining opening 144) all formed in the cutting insert body 126. In one aspect the first inlet coolant channel 134 is parallel to the second inlet coolant channel 137. In another aspect, the first inlet coolant channel 134 (having central longitudinal axis X1-X1) and the second inlet coolant channel 137 (having central longitudinal axis X2-X2) are parallel and offset from the central longitudinal axis B-B (which can also be a central rotational axis of the replaceable cutting insert 124) of the replaceable cutting insert 124.

Still referring to FIG. 6, the first outlet coolant channel 136 includes a longitudinal axis, for example, axis Y-Y and the second outlet coolant channel 138 includes a longitudinal axis, for example, axis Z-Z. In accordance with an aspect of the invention, while the inlet coolant channel 134 is in fluid communication with the first outlet coolant channel 136, the longitudinal axis X1-X1 of the first inlet coolant channel 134 is not axially aligned with the longitudinal axis Y-Y of the first outlet coolant channel 136. In another aspect, the first inlet coolant channel 134 is linear and the first outlet coolant channel 136 is linear and the first inlet coolant channel 134 and the first outlet coolant channel 136 are not axially aligned.

In accordance with an aspect of the invention, while the second inlet coolant channel 137 is in fluid communication with the second outlet coolant channel 138, the longitudinal axis X2-X2 of the second inlet coolant channel 137 is not axially aligned with the longitudinal axis Z-Z of the second outlet coolant channel 138. In another aspect, the second inlet coolant channel 137 is linear and the second outlet coolant channel 138 is linear and the second inlet coolant channel 137 and the second outlet coolant channel 138 are not axially aligned.

In another aspect of the invention, the first outlet coolant channel 136 extends at an angle relative to the first inlet coolant channel 134 and the second outlet coolant channel 138 extends at an angle relative to the second inlet coolant channel 137 as similarly described herein regarding replaceable cutting insert 24 and illustrated in FIG. 4. For example, the first outlet coolant channel 136 may extend at the same or similar angle M relative to the first inlet coolant channel 134 and the second outlet coolant channel 138 may extend at the same or similar angle N relative to the second inlet coolant channel 137. It will be appreciated that for cutting insert 124 the coolant channel 18 formed in tool body 12 would need to be reconfigured to branch apart to accommodate the first inlet coolant channel 134 and the second inlet coolant channel 137.

The tool body 12 portion of the rotary cutting tool 10 is made of, for example, steel or any other suitable materials having similar characteristics and properties. The replaceable cutting insert 24 is made of a hard cutting material, e.g. a tungsten carbide cutting alloy, oxide ceramic or any other suitable materials having similar characteristics and properties.

A method of making a replaceable cutting insert such as, for example, the replaceable cutting insert 24, is also provided. In one aspect, the method includes forming a hard cutting material mixture. As described, the replaceable cutting insert can be made of a hard cutting material, e.g. a tungsten carbide cutting alloy, oxide ceramic or any other suitable materials having similar characteristics and properties. In addition to the hard cutting material, a thermoplastics binder, for example, is added to make the mixture. In one aspect, the thermoplastic binder is mixed above its melting temperature with, for example, a carbide powder so that the powder is well dispersed and the mixture flows well at this temperature.

In another aspect, the method includes injecting the hard cutting material mixture into a die for forming a replaceable cutting insert body (e.g. insert body 26) having an inlet coolant channel (e.g. inlet coolant channel 34) in fluid communication with an outlet coolant channel (e.g. first outlet coolant channel 36), wherein the inlet coolant channel includes a longitudinal axis (e.g. axis X-X) that is not axially aligned with a longitudinal axis of the outlet coolant channel (e.g. axis Y-Y). The cutting insert body can also be formed to have an additional or second outlet coolant channel (e.g. second outlet coolant channel 38) wherein the longitudinal axis of the inlet coolant channel is not axially aligned with a longitudinal axis of the additional or second outlet coolant channel (e.g. axis Z-Z).

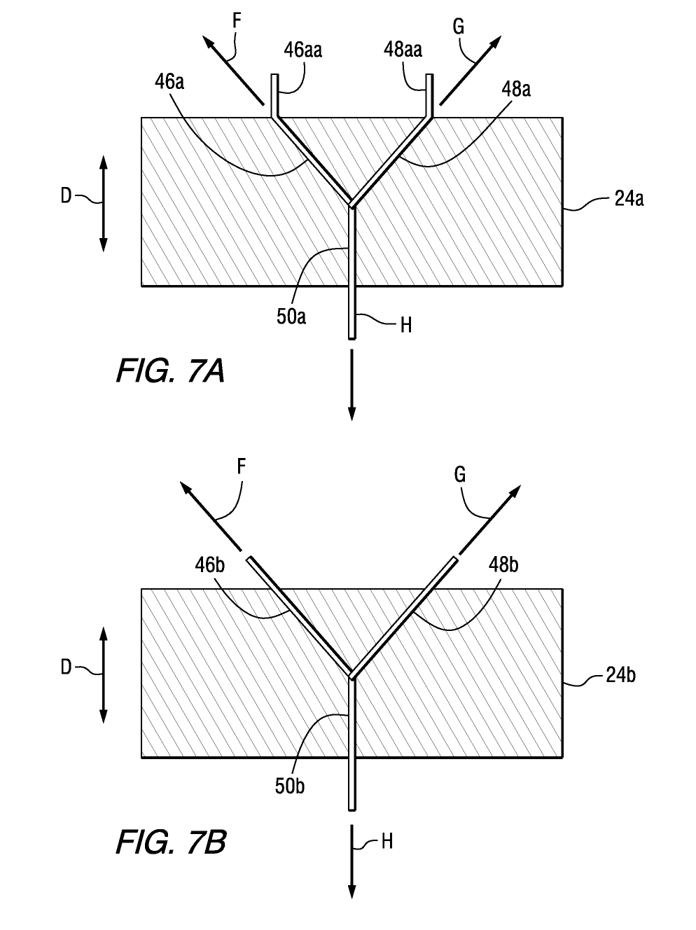

In order to make the replaceable cutting insert having the described structure, or variations thereof, the method also can include forming, for example, replaceable cutting inserts 24a and/or 24b (schematically represented in FIGS. 7A and 7B, respectively) by configuring the die to include a first linear tooling element 46a, 46b for forming the first outlet coolant channel, a second linear tooling element 48a, 48b for forming the second outlet coolant channel and a third linear tooling element 50a, 50b for forming the inlet coolant channel. The first linear tooling element 46a, 46b is configured to be interconnected with the third linear tooling element 50a, 50b, respectively and the second linear tooling element 48a, 48b is also configured to be interconnected with the third linear tooling element 50a, 50b, respectively. In one aspect, the linear tooling elements may be, for example, round pins or like elements shaped and configured to provide the desired shape of the coolant channels to be formed. In another aspect, the linear tooling elements, e.g. pins, may be configured in such a way that they interlock when they contact one another and will separate during removal from the replaceable cutting insert body. This avoids the possibility of flexing the pins during injection, which may cause the channel formed to be discontinuous, or to have other defects such as cracks.

In another aspect, the method includes removing the replaceable cutting insert body and the corresponding linear tooling elements from the die. The removal of the replaceable cutting insert body from the die may be performed in more than one way.

First, referring to FIG. 7A, one aspect of the invention includes removing the replaceable cutting insert body from the die can include withdrawing the first linear tooling element 46a and the second linear tooling element 48a after removing the replaceable cutting insert body from the die. In one aspect, the first and second linear tool elements 46a, 48a are not linear with the die opening action direction (as represented, for example, by arrow D) and therefore cannot be directly removed by the die opening without the assistance of mechanical means, e.g. mechanical cams. Thus, the linear tool elements 46a, 48a may be removed after the part is removed from the die. In order to achieve this, the linear tool elements 46a, 48a are not collinear with each other within the tool cavity, but would most likely change angle at the point that they exit the cavity and enter the die, as illustrated by vertical portions 46aa and 48aa. The angle may change such that both tools are linear with the axis of die opening or part ejection (usually the same axis). This would facilitate removal of the molded insert with the linear tool elements 46a, 48a intact by simple ejection. The vertical portions 46aa and 48aa of the linear tool elements 46a, 48a that protrude from the body are then used to pull the linear tool elements 48a, 50a out of the body in the respective directions as shown by arrows F and G. The linear tool elements 46a, 48a are then secured into the die again for the next injection.

Second, referring to FIG. 7B, another aspect of the invention provides for the removing of the replaceable cutting insert body from the die to include withdrawing the first linear tooling element 46b and the second linear tooling element 48b before removing the replaceable cutting insert body from the die. The first and second linear tooling elements 46b, 48b will extend through the cavity portion of the tool, and are then connected to a hydraulic or mechanical action that is used to remove the linear tooling elements 46b, 48b (in the respective directions as shown by arrows F and G) that could not directly be removed by the opening of the die because they are not collinear to the axis of mold opening /ejection (as represented, for example, by arrow D). The hydraulic or mechanical action is used to remove these linear tooling elements 46b, 48b prior to opening of the die and prior to ejection of the body.

The third linear tooling elements 50a, 50b can be directly removed (in the direction indicated by arrow H) from the cavity by the die opening action, since these elements, e.g. pins are collinear or in the same general direction with the axis of the die opening, e.g. as represented, for example, by arrow D .

Whereas particular aspects of this invention have been described above for purposes of illustration, it will be evident to those skilled in the art that numerous variations of the details of the present invention may be made without departing from the invention as defined in the appended claims.

What is claimed is:

1. A replaceable cutting insert, comprising:
a cutting insert body having a forward cutting face and an opposing rearward base;
an inlet coolant channel formed in the cutting insert body and defining an inlet opening at the rearward base of the cutting insert body, the inlet coolant channel having a longitudinal axis;
a first outlet coolant channel formed in the cutting insert body and in fluid communication with the inlet coolant channel, the first outlet coolant channel defining a first outlet opening at the forward cutting face of the cutting insert body, wherein the first outlet coolant channel includes a first longitudinal axis that is not axially aligned with the longitudinal axis of the inlet coolant channel; and
a second outlet coolant channel formed in the cutting insert body and in fluid communication with the inlet coolant channel, the second outlet coolant channel defining a second outlet opening at the forward cutting face of the cutting insert body, wherein the second outlet coolant channel includes a second longitudinal axis that is not axially aligned with the longitudinal axis of the inlet coolant channel.

2. The replaceable cutting insert of claim 1, wherein the first outlet coolant channel is linear and the second outlet coolant channel is linear.

3. The replaceable cutting insert of claim 2, wherein the inlet coolant channel is linear.

4. The replaceable cutting insert of claim 3, wherein the first outlet coolant channel extends at a first angle relative to the inlet coolant channel, the first angle being in the range of about 90 degrees to about 160 degrees.

5. The replaceable cutting insert of claim 4, wherein the second outlet coolant channel extends at a second angle relative to the inlet coolant channel, the second angle being in the range of about 90 degrees to about 160 degrees.

6. The replaceable cutting insert of claim 5, wherein the first outlet coolant channel extends at a third angle relative to the second outlet coolant channel, the third angle being in the range of about 20 degrees to about 180 degrees.

7. The replaceable cutting insert of claim 1, wherein the longitudinal axis of the inlet coolant channel extends in the same direction as a central rotational axis of the replaceable cutting insert.

8. The replaceable cutting insert of claim 1, wherein the longitudinal axis of the inlet coolant channel is coincident with a central rotational axis of the replaceable cutting insert.

9. A replaceable cutting insert, comprising:
a cutting insert body having a forward cutting face and an opposing rearward base;
a first inlet coolant channel formed in the cutting insert body and defining a first inlet opening at the rearward base of the cutting insert body, the first inlet coolant channel having a first longitudinal axis;
a second inlet coolant channel formed in the cutting insert body and defining a second inlet opening at the rearward base of the cutting insert body, the second inlet coolant channel having a second longitudinal axis;
a first outlet coolant channel formed in the cutting insert body and in fluid communication with the first inlet coolant channel, the first outlet coolant channel defining a first outlet opening at the forward cutting face of the cutting insert body, wherein the first outlet coolant channel includes a third longitudinal axis that is not axially aligned with the first longitudinal axis of the first inlet coolant channel; and
a second outlet coolant channel formed in the cutting insert body and in fluid communication with the second inlet coolant channel, the second outlet coolant channel defining a second outlet opening at the forward cutting face of the cutting insert body, wherein the second outlet coolant channel includes a fourth longitudinal axis that is not axially aligned with the second longitudinal axis of the second inlet coolant channel.

10. The replaceable cutting insert of claim 9, wherein the first outlet coolant channel is linear and the second outlet coolant channel is linear.

11. The replaceable cutting insert of claim 10, wherein the first inlet coolant channel is linear and the second inlet coolant channel is linear.

12. The replaceable cutting insert of claim 11, wherein the first outlet coolant channel extends at a first angle relative to the first inlet coolant channel, the first angle being in the range of about 90 degrees to about 160 degrees.

13. The replaceable cutting insert of claim 12, wherein the second outlet coolant channel extends at a second angle relative to the second inlet coolant channel, the second angle being in the range of about 90 degrees to about 160 degrees.

14. The replaceable cutting insert of claim 9, wherein the first longitudinal axis of the first inlet coolant channel and the second longitudinal axis of the second inlet coolant channel both extend in the same direction as a central rotational axis of the replaceable cutting insert.

15. The replaceable cutting insert of claim 9, wherein the first longitudinal axis of the first inlet coolant channel and the second longitudinal axis of the second inlet coolant channel are parallel.

16. A rotary cutting tool, comprising:
a tool body having an axial forward end and an axial rearward end, the tool body defining a coolant channel that extends therethrough from the axial rearward end to the axial forward end; and
a replaceable cutting insert structured and arranged for releasable attachment to the axial forward end of the tool body, the replaceable cutting insert including:
a cutting insert body having a forward cutting face and an opposing rearward base positionable adjacent the axial forward end of the tool body;
an inlet coolant channel formed in the cutting insert body and defining an inlet opening at the rearward base of the cutting insert body, the inlet coolant channel having a longitudinal axis, wherein the inlet coolant channel is positionable to be in fluid communication with the coolant channel of the tool body;
a first outlet coolant channel formed in the cutting insert body and in fluid communication with the inlet coolant channel, the first outlet coolant channel defining a first outlet opening at the forward cutting face of the cutting insert body, wherein the first outlet coolant channel includes a first longitudinal axis that is not axially aligned with the longitudinal axis of the inlet coolant channel; and
a second outlet coolant channel formed in the cutting insert body and in fluid communication with the inlet coolant channel, the second outlet coolant channel defining a second outlet opening at the forward cutting face of the cutting insert body, wherein the second outlet coolant channel includes a second longitudinal axis that is not axially aligned with the longitudinal axis of the inlet coolant channel.

17. A method of making a replaceable cutting insert, comprising:
forming a hard cutting material mixture;
injecting the hard cutting material mixture into a die for forming a replaceable cutting insert body having an inlet coolant channel in fluid communication with a first outlet coolant channel and a second outlet coolant channel, wherein the first outlet coolant channel includes a first longitudinal axis that is not axially aligned with a longitudinal axis of the inlet coolant channel and the second outlet coolant channel includes a second longitudinal axis that is not axially aligned with the longitudinal axis of the inlet coolant channel; and
removing the replaceable cutting insert body from the die.

18. The method of claim 17, including configuring the die to include a first linear tooling element for forming the first outlet coolant channel, a second linear tooling element for forming the second outlet coolant channel and a third linear tooling element for forming the inlet coolant channel, wherein the first linear tooling element is interconnected with the third linear tooling element and the second linear tooling element is interconnected with the third linear tooling element.

19. The method of claim 18, including withdrawing the first and second linear tooling elements before removing the replaceable cutting insert body from the die.

20. The method of claim 18, including withdrawing the first and second linear tooling elements after removing the replaceable cutting insert body from the die.
